(19) United States
(12) Patent Application Publication
(10) Pub. No.: US 2026/0004966 A1
(43) Pub. Date: Jan. 1, 2026

(54) COIL COMPONENT

(71) Applicant: TAIYO YUDEN CO., LTD., Tokyo (JP)

(72) Inventors: Ryusuke OBATA, Tokyo (JP); Shunpei OTSUKA, Tokyo (JP); Yoshimi SHIKANO, Tokyo (JP)

(21) Appl. No.: 19/240,571

(22) Filed: Jun. 17, 2025

(30) Foreign Application Priority Data
Jun. 26, 2024 (JP) 2024-102752

(51) Int. Cl. H01F 27/30; H01F 5/04; H01F 17/04; H01F 27/28; H01F 27/32

(52) U.S. Cl. CPC H01F 27/306; H01F 5/04; H01F 17/04; H01F 27/2852; H01F 27/323; H01F 2017/048

(57) ABSTRACT

Provided is a coil component in which external electrodes are less likely to be removed off the base body. The coil component includes a base body and first and second external electrodes provided on a first surface of the base body. The base body has first to fifth surfaces. The first external electrode is spaced apart from the second surface of the base body at a first corner region and a second corner region and is in contact with the second surface at a region other than the first corner region and the second corner region. The second external electrode is spaced apart from the third surface of the base body at a third corner region and a fourth corner region and is in contact with the third surface at a region other than the third corner region and the fourth corner region.

### CROSS-REFERENCE TO RELATED APPLICATIONS

This application is based on and claims the benefit of priority from Japanese Patent Application Serial No. 2024-102752 (filed on Jun. 26, 2024), the contents of which are hereby incorporated by reference in their entirety.

### TECHNICAL FIELD

The present disclosure relates mainly to a coil component.

### BACKGROUND

Coil components are passive elements used in electronic devices. For example, coil components are used to eliminate noise in power source lines or signal lines in circuits. Coil components include a base body made of a magnetic material, a coil conductor provided in the base body, and a pair of external electrodes connected to one end and the other end of the coil conductor.

To reduce the size of coil components, external electrodes are sometimes mounted on a single surface (mounting surface) of the base body. For example, Japanese Patent Application Publication No. 2019-125606 (“the '606 Publication”) discloses an inductor with external electrodes mounted only to the mounting surface of the base body.

External electrodes mounted only to the mounting surface of the base body are easily removed off the base body. The '606 Publication discloses that external electrodes can be provided on the mounting surface of the base body at positions spaced apart from the side surfaces, so as to inhibit removal of the external electrodes off the base body.

Placing the external electrodes on the mounting surface of the base body at positions spaced apart from the side surfaces has the positive effect of inhibiting the removal of the external electrodes by allowing less stress generated by the impact applied to the coil component to be transmitted to the external electrodes. On the other hand, such placement also has the negative effect of reducing the contact area between the external electrodes and the mounting surface of the base body, resulting in a lower bonding strength between the external electrodes and the base body, which accelerates the removal of the external electrodes.

### SUMMARY

It is an object of the present disclosure to solve or alleviate at least part of the drawback of the above conventional technique. Particularly, it is an object of the present disclosure to provide a coil component in which external electrodes are less likely to be removed off the base body. The inventions disclosed herein may also address drawbacks other than that grasped from the above description. The various inventions disclosed herein may be collectively referred to as “the invention”.

A coil component according to one aspect of the invention includes: a base body; a coil conductor provided in the base body; a first external electrode provided on a first surface of the base body and connected to one end of the coil conductor; and a second external electrode provided on the first surface of the base body so as to be spaced apart from the first external electrode in a first direction, the second external electrode being connected to another end of the coil conductor. The base body has a first surface, a second surface connected to the first surface, a third surface opposed to the second surface in a first direction and connected to the first surface, a fourth surface connected to the first surface, and a fifth surface opposed to the fourth surface in a second direction orthogonal to the first direction and connected to the first surface. When viewed from a normal direction to the first surface, the first external electrode is spaced apart from the second surface of the base body at a first corner region and a second corner region and is in contact with the second surface at a region other than the first corner region and the second corner region, the first corner region including a first corner where the second surface and the fourth surface intersect, the second corner region including a second corner where the second surface and the fifth surface intersect. When viewed from the normal direction to the first surface, the second external electrode is spaced apart from the third surface of the base body at a third corner region and a fourth corner region and is in contact with the third surface at a region other than the third corner region and the fourth corner region, the third corner region including a third corner where the third surface and the fourth surface intersect, the fourth corner region including a fourth corner where the third surface and the fifth surface intersect.

### ADVANTAGEOUS EFFECTS

One aspect of the invention provides a coil component in which external electrodes are less likely to be removed off the base body.

### BRIEF DESCRIPTION OF THE DRAWINGS

FIG. 1 is a perspective view schematically showing a coil component 1 according to one embodiment of the invention.

FIG. 2 is a plan view of the coil component 1.

FIG. 3 is a sectional view showing, in an enlarged scale, a part of a sectional surface of the coil component 1 cut along the line I-I.

FIG. 4 is a sectional view showing, in an enlarged scale, a part of a sectional surface of the coil component 1 cut along the line II-II.

FIG. 5 is a plan view schematically showing a modification of the coil component 1.

FIG. 6 is a plan view schematically showing a coil component 101 according to another embodiment of the invention.

FIG. 7 is a plan view schematically showing a modification of the coil component 101.

FIG. 8A schematically shows a plurality of magnetic sheets used for manufacturing the coil component 1.

FIG. 8B is a plan view schematically showing a magnetic sheet 57 used for manufacturing the coil component 1.

FIG. 9A is a schematic front view of a mother laminate 50 obtained by stacking the magnetic sheets.

FIG. 9B is a plan view of the mother laminate 50.

### DESCRIPTION OF THE PREFERRED EMBODIMENTS

Various embodiments of the disclosure will be described hereinafter with reference to the appended drawings. Throughout the drawings, the same components are denoted by the same or like reference numerals. For convenience of explanation, the drawings are not necessarily drawn to scale. The following embodiments of the disclosure do not limit the scope of the claims. The elements included in the following embodiments are not necessarily essential to solve the problem addressed by the invention.

### (1) First Embodiment (Coil Component 1)

### (1-1) Basic Structure of Coil Component 1

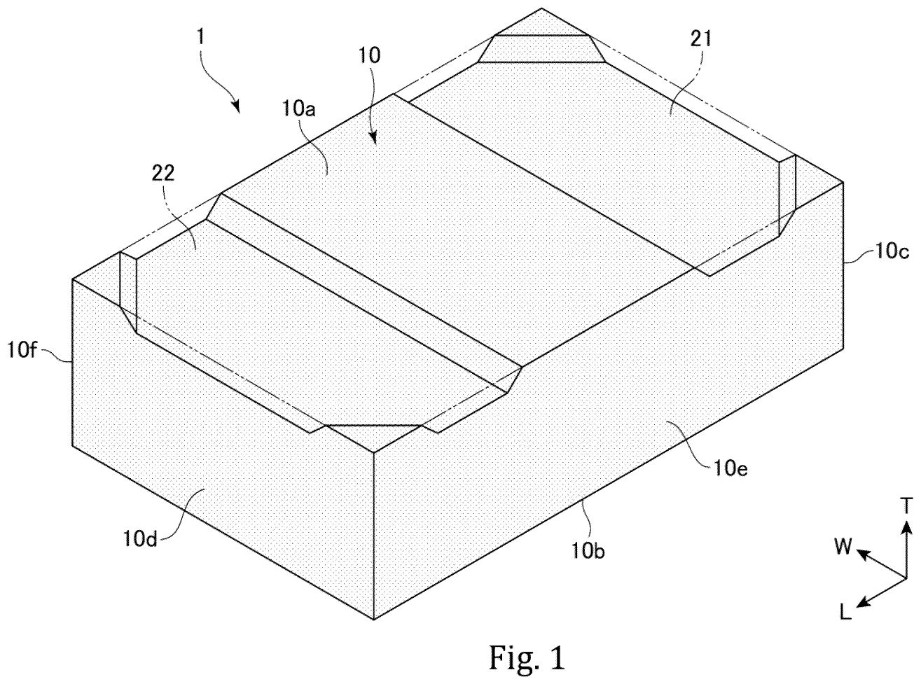

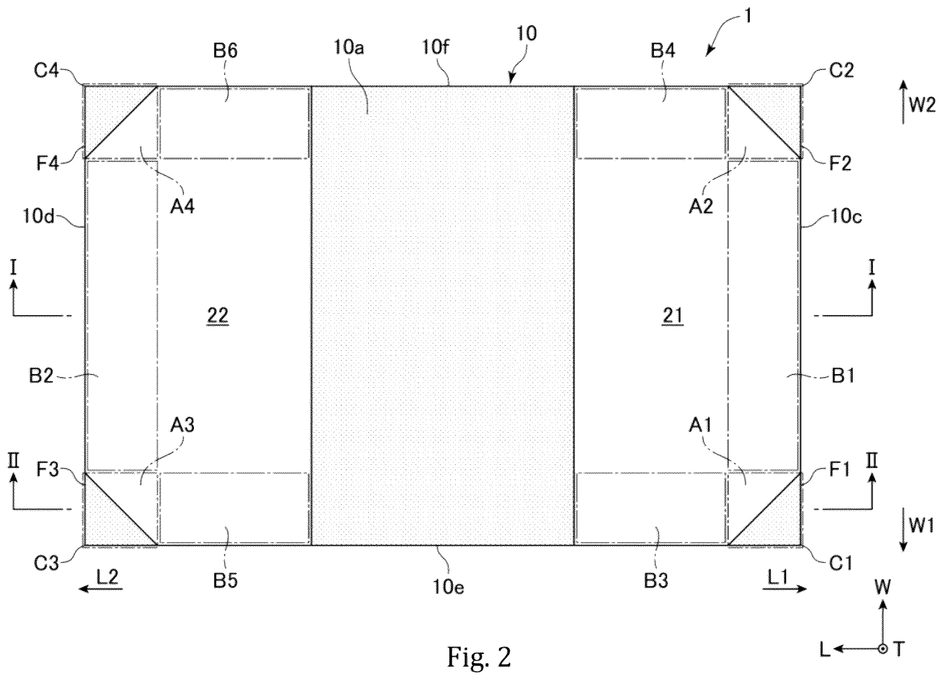

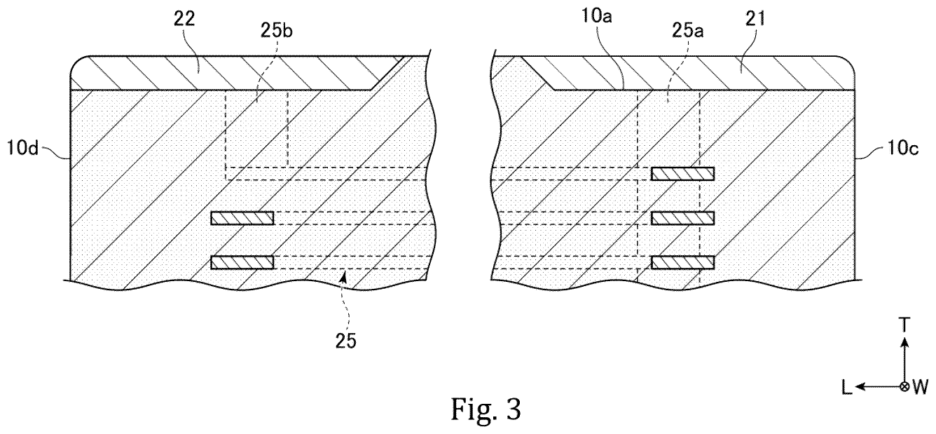

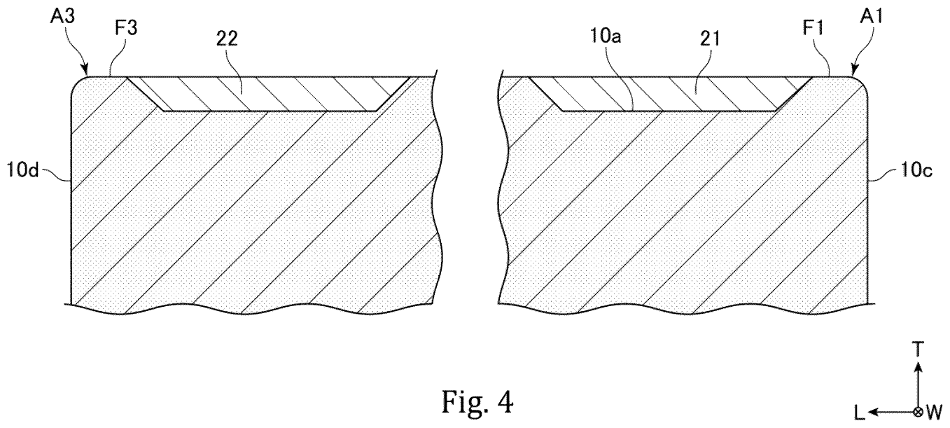

A coil component 1 according to a first embodiment of the invention will be hereinafter described with reference to FIGS. 1 to 4. FIG. 1 is a perspective view schematically showing the coil component 1. FIG. 2 is a plan view of the coil component 1. FIG. 3 is a schematic sectional view showing, in an enlarged scale, a part of a sectional surface of the coil component 1 cut along the line I-I. FIG. 4 is a schematic sectional view showing, in an enlarged scale, a part of a sectional surface of the coil component 1 cut along the line II-II.

For convenience of explanation, each of the drawings may show the L axis, the W axis, and the Taxis orthogonal to one another. In this specification, the dimensions, arrangement, shape, and other features of each constituent of the coil component 1 may be described with reference to the L, W, and Taxes.

Th coil component 1 is used for, e.g., eliminating noise in an electronic circuit. The coil component 1 may be a power inductor built into a power supply line or an inductor used in a signal line.

The coil component 1 includes a base body 10, a coil conductor 25 provided in the base body 10, a first external electrode 21 disposed on a surface of the base body 10, and a second external electrode 22 disposed on the surface of the base body 10 at a position spaced apart from the first external electrode 21. The first external electrode 21 is electrically connected to one end of the coil conductor 25, and the second external electrode 22 is electrically connected to the other end of the coil conductor 25.

### (1-2) Base Body 10

A description is first given of the base body 10. The base body 10 is made of a magnetic material and formed in a rectangular parallelepiped shape. The base body 10 has a top surface 10a, a bottom surface 10b, a first end surface 10c, a second end surface 10d, a first side surface 10e, and a second side surface 10f. The outer surface of the base body 10 is defined by these six surfaces (10a to 10f). The top surface 10a is opposed to the bottom surface 10b in the T-axis direction. The first end surface 10c is opposed to the second end surface 10d in the L-axis direction. The first side surface 10e is opposed to the second side surface 10f in the W-axis direction. The top surface 10a is connected to the upper end of the first end surface 10c at the end in the L1 direction extending along the L axis toward the negative side of the L axis, and connected to the upper end of the second end surface 10d at the end in the L2 direction extending along the L axis toward the positive side of the L axis. The top surface 10a is also connected to the upper end of the first side surface 10e at the end in the W1 direction extending along the W axis toward the negative side of the W axis, and connected to the upper end of the second side surface 10f at the end in the W2 direction extending along the W axis toward the positive side of the W axis. The top surface 10a is an example of the “first surface” recited in the claims. The base body 10 has a “rectangular parallelepiped shape.” The term “rectangular parallelepiped” used herein is not intended to mean solely “rectangular parallelepiped” in a mathematically strict sense. The corners and ridges of the base body 10 may be rounded.

The base body 10 may contain a plurality of metal magnetic particles bonded to one another. The surfaces of the metal magnetic particles are coated with insulating films. Thus, the metal magnetic particles are insulated from one another. If the insulating films on the surfaces of the metallic magnetic particles are broken, the insulation resistance of the base body 10 will be low. Therefore, an insulating film may be provided on the surface of the base body 10. In other words, the base body 10 may have an insulating film (not shown). The insulating film may be provided to cover a region of the top surface 10a of the base body 10 where no external electrodes are provided. The insulating film is made of an insulating material having an excellent insulation property. The insulating film has a higher electric resistivity than the base body 10. The insulating material is, for example, a resin material such as silicon resin, epoxy resin, and phenol resin, glass such as borosilicate glass, and a metal oxide such as Al oxide.

### (1-3) Coil Conductor 25

Next, a description is given of the coil conductor 25. The coil conductor 25 is made of conductive materials having excellent conductivity, such as Ag, Pd, Cu, Al or alloys of these. The coil conductor 25 may be formed in various shapes in accordance with the type of the coil component 1. The coil conductor 25 is configured to have a shape that produces a desired inductance. The coil conductor 25 has, for example, a spiral shape that is wound around the coil axis for a predetermined number of turns. The coil conductor 25 may have a linear shape.

As shown in FIG. 3, the coil conductor 25 includes a first lead-out portion 25a and a second lead-out portion 25b. Both the first and second lead-out portions 25a and 25b are exposed from the top surface 10a to the outside of the base body 10. The coil conductor 25 is connected to the first external electrode 21 at the first lead-out portion 25a and connected to the second external electrode 22 at the second lead-out portion 25b.

### (1-4) First External Electrode 21 and Second External Electrode 22

Next, a description is given of the first external electrode 21 and the second external electrode 22. Both the first external electrode 21 and the second external electrode 22 are disposed on the top surface 10a of the base body 10. In the embodiment shown, the top surface 10a of the base body 10 has recesses formed therein and shaped to conform to the first external electrode 21 and the second external electrode 22, and the first external electrode 21 and the second external electrode 22 are received in these recesses. The first external electrode 21 is spaced apart from the second external electrode 22 in the L-axis direction. As described above, the first external electrode 21 is connected to one end of the coil conductor 25, and the second external electrode 22 is connected to the other end of the coil conductor 25.

The configuration of the first and second external electrodes 21 and 22 and their arrangement on the top surface 10a are explained mainly with reference to FIG. 2. When viewed in the normal direction to the top surface 10a (i.e., in the T-axis direction), the first external electrode 21 is cut at a portion facing the first corner C1 where the first end surface 10c and the first side surface 10e of the base body 10 intersect and at a portion facing the second corner C2 where the first end surface 10c and the second side surface 10f intersect. Therefore, the first external electrode 21 is spaced apart from the first end surface 10c and the first side surface 10e at the first corner region A1 including the first corner C1 and also spaced apart from the first end surface 10c and the second side surface 10f at the second corner region A2 including the second corner C2. On the other hand, the first external electrode 21 is in contact with the first end surface 10c at the intermediate region B1 interposed between the first corner region A1 and the second corner region A2 in the W-axis direction. In other words, the first external electrode 21 does not extend to the end of the top surface 10a in the L1 direction at the first and second corner regions A1 and A2, but extends to the end of the top surface 10a in the L1 direction at the intermediate region B1 between the first and second corner regions A1 and A2. Therefore, the first external electrode 21 is in contact with the upper end of the first end surface 10c at the intermediate region B1, which is interposed between the first and second corner regions A1 and A2 in the W-axis direction.

When viewed in the normal direction to the top surface 10a, the second external electrode 22 is cut at a portion facing the third corner C3 where the second end surface 10d and the first side surface 10e of the base body 10 intersect and at a portion facing the fourth corner C4 where the second end surface 10d and the second side surface 10f intersect. Therefore, the second external electrode 22 is spaced apart from the second end surface 10d and the first side surface 10e at the third corner region A3 including the third corner C3 and also spaced apart from the second end surface 10d and the second side surface 10f at the fourth corner region A4 including the fourth corner C4. On the other hand, the second external electrode 22 is in contact with the second end surface 10d at the intermediate region B2 interposed between the third corner region A3 and the fourth corner region A4 in the W-axis direction. In other words, the second external electrode 22 does not extend to the end of the top surface 10a in the L2 direction at the third and fourth corner regions A3 and A4, but extends to the end of the top surface 10a in the L2 direction at the intermediate region B2 between the third and fourth corner regions A3 and A4. Therefore, the second external electrode 22 is in contact with the upper end of the second end surface 10d at the intermediate region B2, which is interposed between the third and fourth corner regions A3 and A4 in the W-axis direction.

In the embodiment shown, the first and second external electrodes 21 and 22 are also in contact with the first and second side surfaces 10e and 10f. Specifically, the first external electrode 21 is in contact with the first side surface 10e at the intermediate region B3, which is located between the first corner region A1 and the third corner region A3 and adjacent to the first corner region A1 in the L-axis direction. The first external electrode 21 is also in contact with the second side surface 10f at the intermediate region B4, which is located between the second corner region A2 and the fourth corner region A4 and adjacent to the second corner region A2 in the L-axis direction. The second external electrode 22 is in contact with the first side surface 10e at the intermediate region B5, which is located between the first corner region A1 and the third corner region A3 and adjacent to the third corner region A3 in the L-axis direction. The second external electrode 22 is also in contact with the second side surface 10f at the intermediate region B6, which is located between the second corner region A2 and the fourth corner region A4 and adjacent to the fourth corner region A4 in the L-axis direction.

When viewed from the normal direction to the top surface 10a, the first corner region A1 has a rectangular or square shape one of the vertices of which is formed by the first corner C1. Similarly, the second corner region A2 has a rectangular or square shape one of the vertices of which is formed by the second corner C2, the third corner region A3 has a rectangular or square shape one of the vertices of which is formed by the third corner C3, and the fourth corner region A4 has a rectangular or square shape one of the vertices of which is formed by the fourth corner C4.

Since the first external electrode 21 is spaced apart from the first end surface 10c and the first side surface 10e at the first corner region A1 and spaced apart from the first end surface 10c and the second side surface 10f at the second corner region A2, when viewed from the normal direction to the top surface 10a, in part of the first corner region A1 and the second corner region A2, the top surface 10a of the base body 10 is not covered by the first external electrode 21 and is exposed through the cutouts of the first external electrode 21. The region of the top surface 10a exposed from the first external electrode 21 at the first corner region A1 includes a flat surface F1 extending along the LW plane. As shown in FIG. 4, in the first corner region A1, the ridge connecting the top surface 10a and the first end surface 10c is rounded. Each of the ridges connecting the top surface 10a to the second end surface 10d, the first side surface 10e, or the second side surface 10f is also rounded. The flat surface F1 in the top surface 10a is located inside the rounded ridge between the top surface 10a and the first end surface 10c and the rounded ridge between the top surface 10a and the first side surface 10e. The region of the top surface 10a exposed from the first external electrode 21 at the second corner region A2 includes a flat surface F2 extending along the LW plane. The flat surface F2 in the top surface 10a is located inside the rounded ridge between the top surface 10a and the first end surface 10c and the rounded ridge between the top surface 10a and the second side surface 10f.

Since the second external electrode 22 is spaced apart from the second end surface 10d and the first side surface 10e at the third corner region A3 and spaced apart from the second end surface 10d and the second side surface 10f at the fourth corner region A4, when viewed from the normal direction to the top surface 10a, in part of the third corner region A3 and the fourth corner region A4, the top surface 10a of the base body 10 is not covered by the second external electrode 22 and is exposed through the cutouts of the second external electrode 22. The region of the top surface 10a exposed from the second external electrode 22 at the third corner region A3 includes a flat surface F3 extending along the LW plane. The flat surface F3 in the top surface 10a is located inside the rounded ridge between the top surface 10a and the second end surface 10d and the rounded ridge between the top surface 10a and the first side surface 10e. The region of the top surface 10a exposed from the second external electrode 22 at the fourth corner region A4 includes a flat surface F4 extending along the LW plane. The flat surface F4 in the top surface 10a is located inside the rounded ridge between the top surface 10a and the second end surface 10d and the rounded ridge between the top surface 10a and the second side surface 10f.

When an insulating film is provided on the top surface 10a of the base body 10, the insulating film is exposed through the cutout of the first external electrode 21 and the cutout of the second external electrode 22 in part of the first corner region A1, second corner region A2, third corner region A3, and fourth corner region A4.

The dimensions of the first corner region A1, second corner region A2, third corner region A3, and fourth corner region A4 in the W-axis direction can be equal to or smaller than 1/10 of the dimension of the top surface 10a in the W-axis direction. The dimensions of the first corner region A1, second corner region A2, third corner region A3, and fourth corner region A4 in the L-axis direction can be equal to or smaller than 1/10 of the dimension of the top surface 10a in the L-axis direction.

The first and second external electrodes 21 and 22 may each include a base electrode layer and a plating layer covering the base electrode layer. The base electrode layer is formed by, for example, applying a paste-like electrically conductive material to the top surfaces 10a of the base body 10 and curing the electrically conductive material thus applied. The electrically conductive material for the base electrode layer may be, for example, a metal material such as Cu, Ni, Ag, Pd, or Au, or an alloy material containing one or more of these metal materials. The plating layer is formed, by electrolytic plating for example, on the surface of the base electrode layer to cover the base electrode layer. The plating layer may have two-layer structure. The plating layer having the two-layer structure includes, for example, a first plating layer formed on the base electrode layer and a second plating layer formed on the first plating layer. For example, the first plating layer may be a nickel plating layer, and the second plating layer may be a tin plating layer.

### (1-5) Mechanism for Inhibiting Removal

In the conventional art, if the external electrode provided on the mounting surface extends to the side surface or the end surface of the base body, when an external impact is applied to the coil component, interface failure starts at a point in the interface between the base body and the external electrode that is exposed from the side surface or the end surface of the base body. When a crack extends from the starting point of the interface failure along the interface, the external electrode is removed off the base body. The '606 Publication discloses that the external electrodes are located on the mounting surface of the base body at positions spaced apart from the side surfaces or the end surfaces of the base body, so as to inhibit removal of the external electrodes off the base body.

However, if the entire external electrodes provided on the mounting surface of the base body are spaced apart from the side surfaces and the end surfaces of the base body, as in the inductor disclosed in the '606 Publication, the contact area between the external electrodes and the base body is reduced, and the reduced contact area lowers the bonding strength between the external electrodes and the base body. Therefore, the effect of inhibiting the removal by spacing the external electrodes apart from the side surfaces and the end surfaces of the base body is reduced to some extent by the reduction of the contact area.

By contrast, in the present invention, the first external electrode 21 and the second external electrode 22 are arranged on the top surface 10a of the base body 10 such that the first external electrode 21 and the second external electrode 22 are spaced apart from the end surfaces and the side surfaces of the base body 10 in the first corner region A1, the second corner region A2, the third corner region A3, and the fourth corner region A4 near the corners of the base body 10 where stress is most concentrated when the coil component 1 is subjected to an impact, while the first external electrode 21 and the second external electrode 22 extend to the ends of the top surface 10a of the base body 10 in the regions other than the first corner region A1, the second corner region A2, the third corner region A3, and the fourth corner region A4. Thus, interface failure can be inhibited from occurring, and the reduction of the contact area can be minimized, thereby inhibiting the first external electrode 21 and the second external electrode 22 from being removed off the top surface 10a of the base body 10.

According to CAE (Computer Aided Engineering) analysis conducted by the inventors, it was confirmed that when an indenter is pressed into a coil component mounted on a board at a speed of 2 mm/second from the board side toward the coil component, the stress is concentrated near the corners of the coil component having a cubic shape. In particular, when viewed from the normal direction to the top surface 10a, the stress in the regions corresponding to the first corner region A1, the second corner region A2, the third corner region A3, and the fourth corner region A4 (i.e., the rectangular regions each having vertices one of which is formed by one of the corners, having a dimension in the L-axis direction that is 1/10 of the dimension of the base body in the L-axis direction, and having a dimension in the W-axis direction that is 1/10 of the dimension of the base body in the W-axis direction) was about two to three times the stress in the other regions. This stress distribution did not change significantly for different dimensional ratios of the coil component or different speeds of the indenter. These analysis results show that, in a coil component having a cubic shape, interface failure tends to start at a point near the corners of the base body, while interface failure is much less likely to occur in the regions of the ridges on the top surface of the base body that are connected to the end surfaces or the side surfaces and are spaced apart from the corners (for example, the intermediate regions B1 to B6 of the coil component 1) than in the regions near the corners.

In the invention, the first external electrode 21 and the second external electrode 22 are spaced apart from the end surfaces and the side surfaces of the base body 10 at the first corner region A1, the second corner region A2, the third corner region A3, and the fourth corner region A4, where stress is particularly concentrated when an external impact is applied to the coil component 1. This arrangement inhibits the stress generated by an external impact from causing interface failure to start at a point between the first external electrode 21 or the second external electrode 22 and the top surface 10a of the base body 10. Also, the first external electrode 21 and the second external electrode 22 extend to the ends of the top surface 10a of the base body 10 in regions other than the first corner region A1, the second corner region A2, the third corner region A3, and the fourth corner region A4 (i.e., the intermediate regions B1 to B6). This arrangement allows for a larger contact area between each of the first and second external electrodes 21 and 22 and the top surface 10a of the base body 10 than in conventional coil components in which the entire external electrodes are spaced apart from the side surfaces and the end surfaces of the base body. Thus, in the coil component 1, the reduction of the contact areas between the first external electrode 21 and the top surface 10a and between the second external electrode 22 and the top surface 10a can be minimized, and interface failure can be inhibited from starting at a point between the first external electrode 21 or the second external electrode 22 and the top surface 10a of the base body 10. Therefore, the first external electrode 21 and the second external electrode 22 are less likely to be removed off the top surface 10a of the base body 10.

### (1-6) Modifications

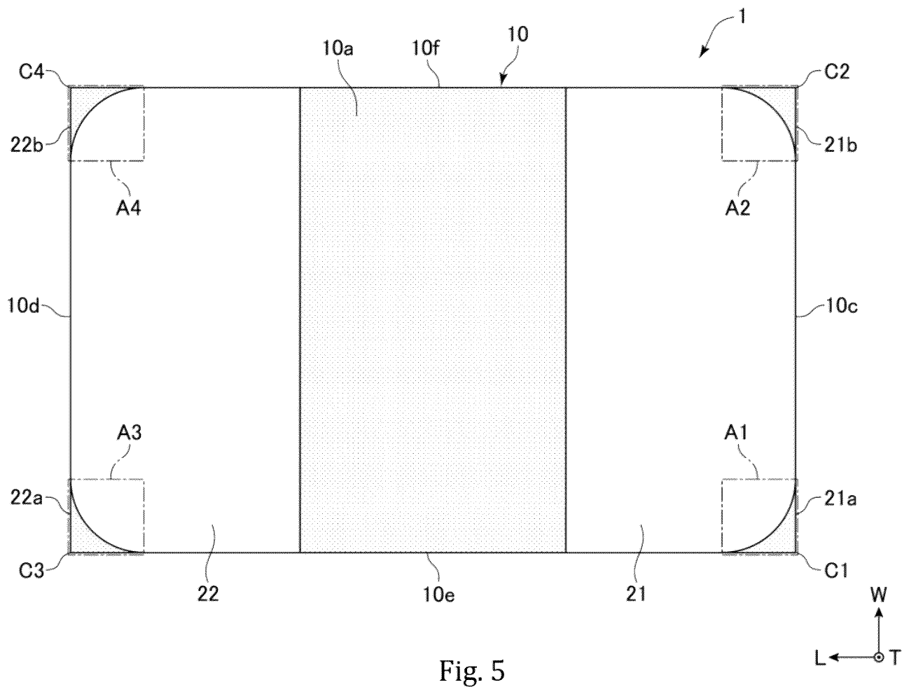

In the embodiment described above, when viewed from the direction normal to the top surface 10a, the shapes of the first and second external electrodes 21 and 22 are not limited to those shown in FIG. 2. A modification of the shapes of the first external electrode 21 and the second external electrode 22 in plan view will be hereinafter described with reference to FIG. 5. In FIG. 5, the shapes of the first and second external electrodes 21 and 22 are modified compared to the embodiment shown in FIG. 2. Specifically, in the embodiment shown in FIG. 5, the first external electrode 21 has a curved portion 21a curved convexly toward the first corner C1, and a curved portion 21b curved convexly toward the second corner C2. The second external electrode 22 has a curved portion 22a curved convexly toward the third corner C3, and a curved portion 22b curved convexly toward the fourth corner C4.

In the embodiment shown in FIG. 5, when viewed from the normal direction to the top surface 10a, the first external electrode 21 has a cornerless shape in the first corner region A1 and the second corner region A2, so that when the coil component 1 is subjected to an external impact, the concentration of stress can be mitigated on the internal regions of the first corner region A1 and the second corner region A2 in the first external electrode 21. Thus, it is even less likely that the interface failure starts at a point in the first and second corner regions A1 and A2. This further inhibits the first external electrode 21 from being removed off the base body 10. Similarly, when the coil component 1 is subjected to an external impact, the concentration of stress can be mitigated on the internal regions of the third corner region A3 and the fourth corner region A4 in the second external electrode 22. Thus, it is even less likely that the interface failure starts at a point in the third and fourth corner regions A3 and A4. This further inhibits the second external electrode 22 from being removed off the base body 10.

### (2) Second Embodiment (Coil Component 101)

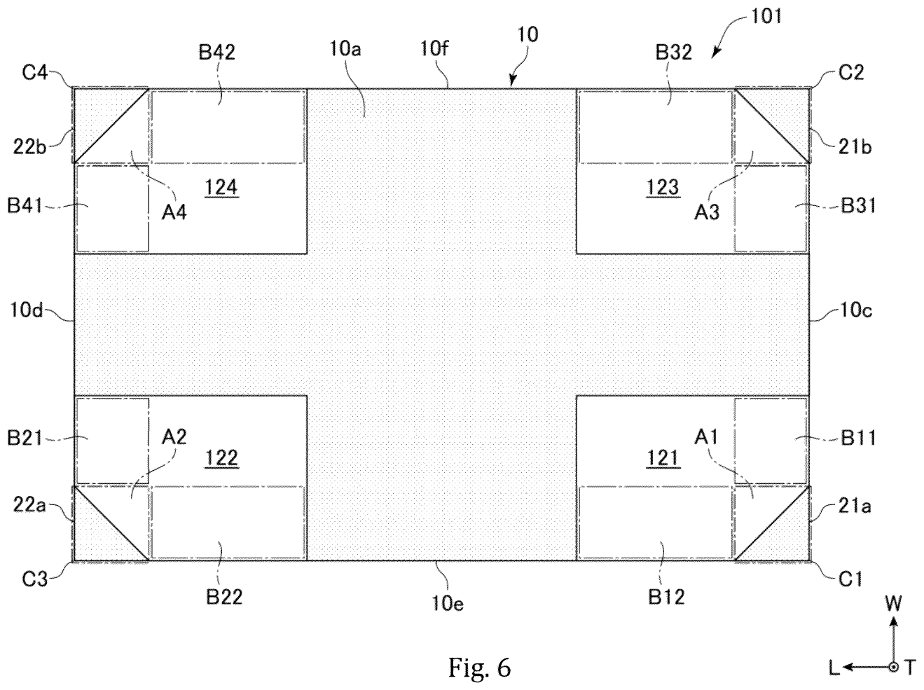

Next, a coil component 101 according to the second embodiment will be described with reference to FIG. 6. FIG. 6 is a plan view showing the coil component 101 according to the second embodiment. The coil component 101 includes four external electrodes, unlike the coil component 1 including two external electrodes. The coil component 101 may include, for example, a magnetically coupled inductor (e.g., common mode choke coil). The elements of the coil component 101 that are the same as or similar to those of the coil component 1 will not be described again.

As shown in FIG. 6, the coil component 101 includes a first external electrode 121, a second external electrode 122, a third external electrode 123, and a fourth external electrode 124. The first external electrode 121 is positioned opposite the first corner C1. The second external electrode 122 is spaced apart from the first external electrode 121 in the L-axis direction and positioned opposite the third corner C3. The third external electrode 123 is spaced apart from the first external electrode 121 in the W-axis direction and positioned opposite the second corner C2. The fourth external electrode 124 is spaced apart from the second external electrode 122 in the W-axis direction and positioned opposite the fourth corner C4.

The coil component 101 includes two coil conductors (not shown) disposed in the base body 10. These two coil conductors are, for example, a first coil conductor and a second coil conductor. The first coil conductor and the second coil conductor are electrically insulated from each other in the base body 10. The first external electrode 121 is connected to one end of the first coil conductor, and the second external electrode 122 is connected to the other end of the first coil conductor. The third external electrode 123 is connected to one end of the second coil conductor (not shown), and the fourth external electrode 124 is connected to the other end of the second coil conductor. It is also possible that the third external electrode 123, instead of the second external electrode 122, be connected to the other end of the first coil conductor. When the first external electrode 121 is connected to one end of the first coil conductor and the third external electrode is connected to the other end of the first external electrode 121, the second external electrode 122 is connected to one end of the second coil conductor, and the fourth external electrode 124 is connected to the other end of the second coil conductor.

The following further describes the arrangement of the first to fourth external electrodes 121 to 124 on the top surface 10a. When viewed from the normal direction to the top surface 10a, the first external electrode 121 is arranged so as to be spaced apart from the first end surface 10c and the first side surface 10e at the first corner region A1, but in contact with the first end surface 10c at the intermediate region B11 that is interposed between the first corner region A1 and the third corner region A3 and adjacent to the first corner region A1 in the W-axis direction, and in contact with the first side surface 10e at the intermediate region B12 that is interposed between the first corner region A1 and the second corner region A2 and adjacent to the first corner region A1 in the L-axis direction.

When viewed from the normal direction to the top surface 10a, the second external electrode 122 is arranged so as to be spaced apart from the second end surface 10d and the first side surface 10e at the second corner region A2, but in contact with the second end surface 10d at the intermediate region B21 that is interposed between the second corner region A2 and the fourth corner region A4 and adjacent to the second corner region A2 in the W-axis direction, and in contact with the first side surface 10e at the intermediate region B22 that is interposed between the first corner region A1 and the second corner region A2 and adjacent to the second corner region A2 in the L-axis direction.

When viewed from the normal direction to the top surface 10a, the third external electrode 123 is arranged so as to be spaced apart from the first end surface 10c and the second side surface 10f at the third corner region A3, but in contact with the first end surface 10c at the intermediate region B31 that is interposed between the first corner region A1 and the third corner region A3 and adjacent to the third corner region A3 in the W-axis direction, and in contact with the second side surface 10f at the intermediate region B32 that is interposed between the third corner region A3 and the fourth corner region A4 and adjacent to the third corner region A3 in the L-axis direction.

When viewed from the normal direction to the top surface 10a, the fourth external electrode 124 is arranged so as to be spaced apart from the second end surface 10d and the second side surface 10f at the fourth corner region A4, but in contact with the second end surface 10d at the intermediate region B41 that is interposed between the second corner region A2 and the fourth corner region A4 and adjacent to the fourth corner region A4 in the W-axis direction, and in contact with the second side surface 10f at the intermediate region B42 that is interposed between the third corner region A3 and the fourth corner region A4 and adjacent to the fourth corner region A4 in the L-axis direction.

In the coil component 101, the first to fourth external electrodes 121 to 124 are spaced apart from the end surfaces and the side surfaces at the first corner region A1, the second corner region A2, the third corner region A3, and the fourth corner region A4, where stress is most concentrated when an impact is applied to the coil component 101. This arrangement inhibits interface failure from starting at a point in the first to fourth external electrodes 121 to 124, where stress is most concentrated. The first to fourth external electrodes 121 to 124 are in contact with the corresponding end surfaces and side surfaces at the intermediate regions (the intermediate regions B11, B12, . . . B42) that are outside the first to fourth corner regions A1 to A4. This arrangement inhibits interface failure from occurring and minimizes the reduction of the contact area. Thus, the first to fourth external electrodes 121 to 124 can be inhibited from being removed off the top surface 10a of the base body 10.

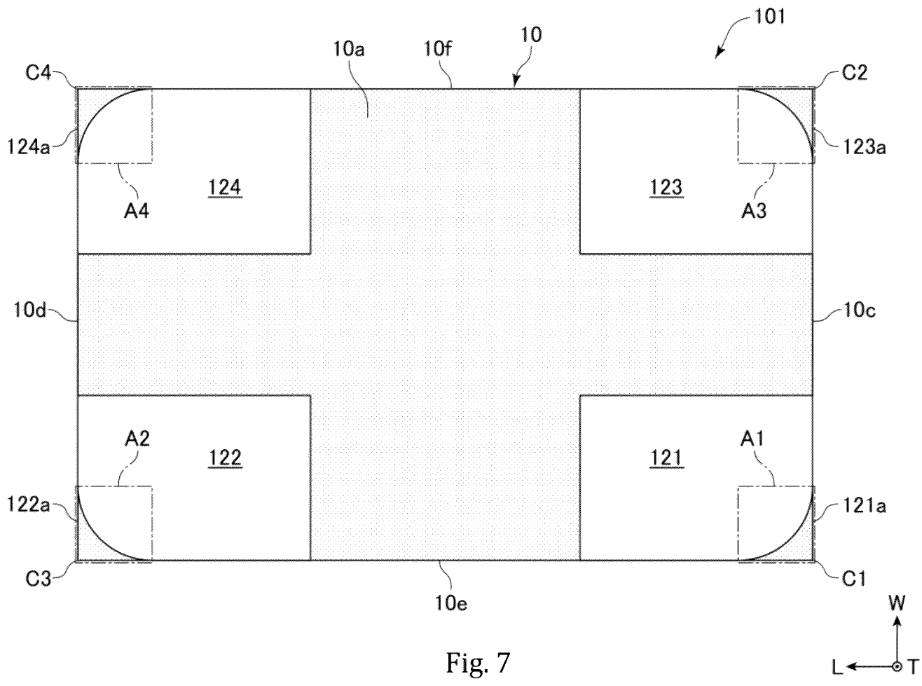

In the coil component 101, when viewed from the direction normal to the top surface 10a, the shapes of the first to fourth external electrodes 121 to 124 are not limited to those shown in FIG. 6. A modification of the shapes of the first to fourth external electrodes 121 to 124 in plan view will be hereinafter described with reference to FIG. 7. In the embodiment shown in FIG. 7, the first external electrode 121 has a curved portion 121a curved convexly toward the first corner C1, the second external electrode 122 has a curved portion 122a curved convexly toward the third corner C3, the third external electrode 123 has a curved portion 123a curved convexly toward the second corner C2, and the fourth external electrode 124 has a curved portion 124a curved convexly toward the fourth corner C4.

In the embodiment shown in FIG. 7, when viewed from the normal direction to the top surface 10a, each of the first to fourth external electrodes 121 to 124 has a cornerless shape in corresponding one of the first to fourth corner regions A1 to A4, so that when the coil component 101 is subjected to an external impact, the concentration of stress can be mitigated on the internal regions of the first to fourth corner regions A1 to A4 in the first to fourth external electrodes 121 to 124. Thus, it is less likely that the interface failure starts at a point in the first to fourth corner regions A1 to A4. This inhibits the first to fourth external electrodes 121 to 124 from being removed off the base body 10.

### (3) Method of Manufacturing Coil Component 1

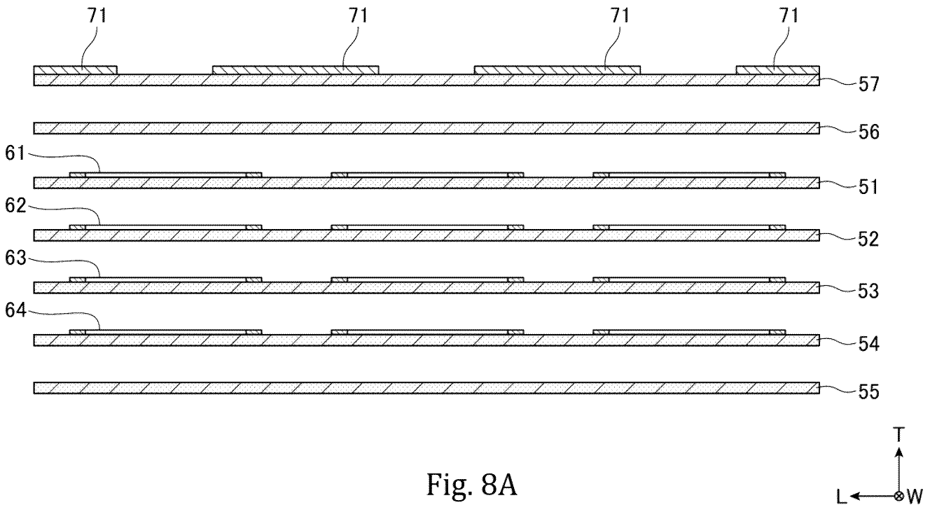

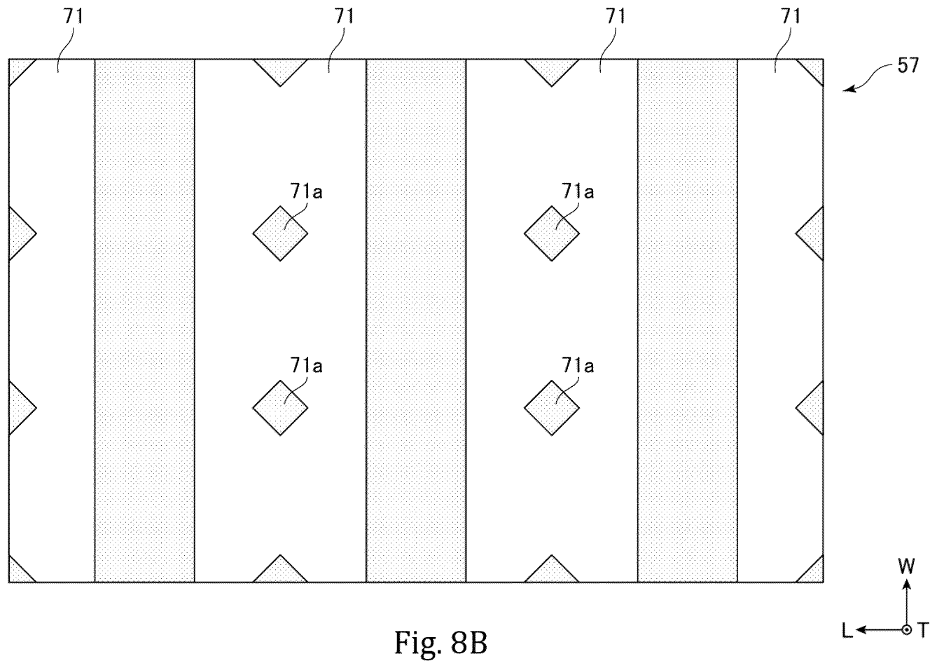

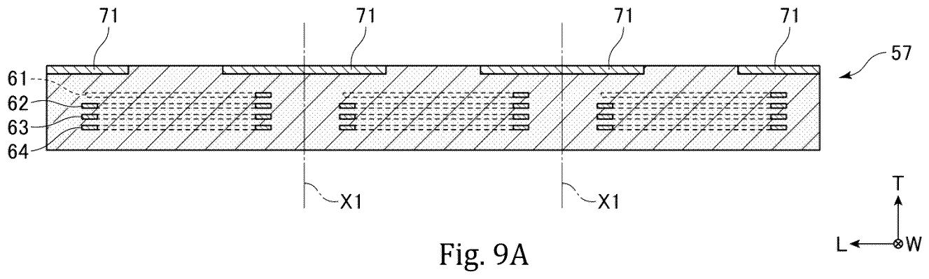

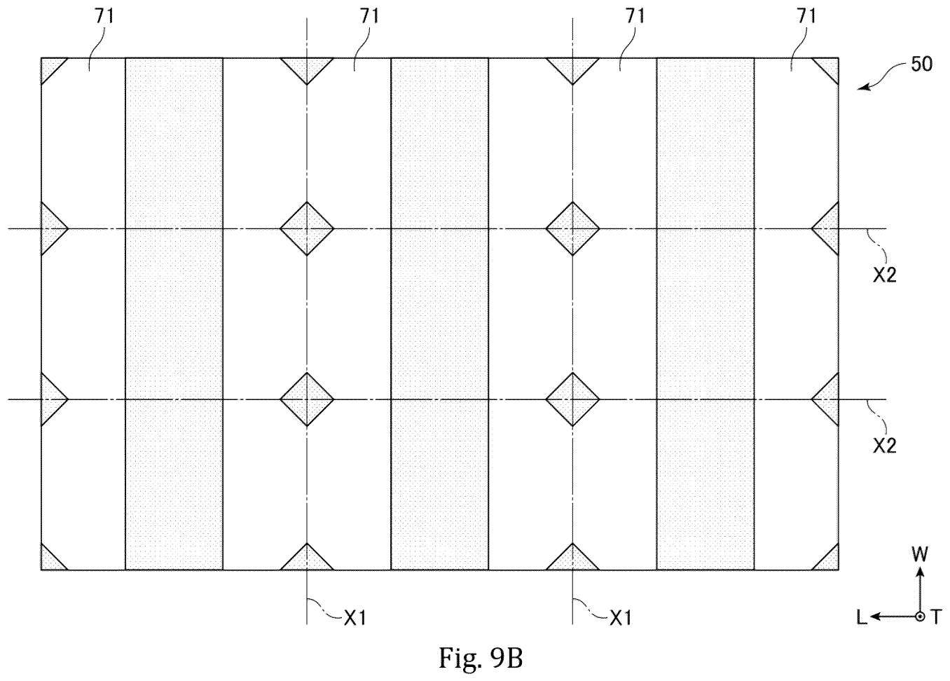

Next, one example of a manufacturing method of the coil component 1 will be described with reference to FIGS. 8A, 8B, 9A, and 9B. In the following, it is assumed that the coil component 1 is manufactured by the sheet lamination method. The coil component 1 may also be manufactured by any known methods other than the sheet lamination method. For example, the coil component 1 may be manufactured by a lamination method such as a printing lamination method, a thin-film process method, or a slurry build method.

The first step of the sheet lamination method for manufacturing the coil component 1 is to produce a plurality of magnetic sheets. The magnetic sheets are produced from a magnetic material paste obtained by mixing and kneading soft magnetic metal powder (raw powder), which is the raw material of the metal magnetic particles, with a binder resin and a solvent. The raw powder contains, for example, Fe and additive elements. The additive elements are, for example, one or more of Si, Cr, and Al. The binder resin for the magnetic material paste is, for example, an acrylic resin. The binder resin for the magnetic material paste may be PVB resins, phenolic resins, other resins known as binder resins, or mixtures thereof. One example of the solvent is toluene.

To produce the magnetic sheets, the magnetic material paste is applied to the surface of a plastic base film by the doctor blade method or other common methods. The magnetic material paste applied to the surface of the base film is dried to obtain sheet-shaped compacts. A molding pressure of approximately 10 MPa to 100 MPa is applied for molding to the sheet-shaped compacts in the mold, so that the magnetic sheets are obtained. FIG. 8A schematically shows the magnetic sheets 51 to 57 produced as described above.

Next, a conductive paste is applied to some of the plurality of magnetic sheets. In the example shown in FIG. 8A, the conductive paste is applied to magnetic sheets 51 to 54 out of the magnetic sheets 51 to 57. The conductive paste is produced by mixing and kneading conductive powder made of conductive materials having excellent conductivity, such as Ag, Pd, Cu, Al or alloys of these, with a binder resin and a solvent. The binder resin for the conductive paste may be the same as the binder resin for the magnetic material paste. By applying the conductive paste to the magnetic sheets 51 to 54, unfired conductor patterns 61 to 64 are formed on the magnetic sheets 51 to 54. The conductive paste is applied to the magnetic sheets by, for example, screen printing.

The magnetic sheets 51 to 53 and 56 to 57 have through holes (not shown) that penetrate these magnetic sheets in the stacking direction, and a conductive paste is placed into these through holes. The conductive paste placed into the through holes forms unfired via conductors. The via conductors are positioned to connect the conductor patterns formed on adjacent magnetic sheets. For example, the via conductor provided in a through hole formed in the magnetic sheet 51 connects the conductor pattern 61 formed on the top surface of magnetic sheet 51 with the conductor pattern 62 formed on the top surface of the magnetic sheet 52 that is adjacent to the magnetic sheet 51. The unfired conductor patterns 61 to 64 and the unfired via conductors are formed into the coil conductor 25 after firing.

On the magnetic sheet 57, there are formed conductor patterns 71, which will form the base electrode layer for the first and second external electrodes 21 and 22 after firing. As shown in FIG. 8B, the conductor patterns 71 formed on the magnetic sheet 57 have through holes 71a arranged at regular intervals in the W-axis and L-axis directions. When the magnetic sheet 57 having the conductor patterns 71 formed thereon is viewed in plan view (i.e., from the perspective of FIG. 8B), the magnetic sheet 57 is exposed through the through holes 71a. The conductor patterns 71 may be formed by applying to the magnetic sheet 57 the same conductive paste as the conductor patterns 61 to 64. The conductor patterns 71 may contain a different conductive material than the conductor patterns 61 to 64.

Of the magnetic sheets 51 to 57, the magnetic sheets 55 and 56 have no conductor pattern formed thereon. The magnetic sheets 55 and 56 form cover layers in the coil component 1, interposed between the bottom surface 10b of the base body 10 and the conductor patterns 61 to 64 and between the top surface 10a and the conductor patterns 61 to 64. The magnetic sheet 56 has through holes formed therein, and the conductive paste placed in these through holes form, after firing, the first lead-out portion 25a and the second lead-out portion 25b that lead out the coil conductor 25 to the top surface 10a of the base body 10.

Next, the magnetic sheets 51 to 57 are stacked and the stacked magnetic sheets 51 to 57 are pressure-bonded together to obtain a mother laminate 50 shown in FIGS. 9A and 9B. During the pressure bonding, the magnetic sheets are pressurized in the stacking direction, so that the conductor patterns 71 are embedded inside the mother laminate 50. In the pressure bonding process for producing the mother laminate 50, the stacked magnetic sheets 51 to 57 may be pressurized at such a pressure that the top surfaces of the conductor patterns 71 and the top surface of the mother laminate 50 are flush with each other.

Next, the mother laminate 50 is cut along the cutting planes X1 and X2 shown in FIGS. 9A and 9B to produce diced, unfired chip laminates. The cutting planes X1 are planes that extend through the respective centers of the through holes 71a formed in the conductor patterns 71 and extend parallel to the WT plane. The cutting planes X2 are planes that extend through the respective centers of the through holes 71a formed in the conductor patterns 71 and extend parallel to the LT plane. The mother laminate 50 may be cut by, for example, a push-cut blade or a rotary blade. The mother laminate 50 may be cut by a cutter such as a dicing machine or a laser processing machine.

Next, the chip laminate obtained by dicing the mother laminate 50 is fired. Through firing of the chip laminate, the pressure-bonded magnetic sheets 51 to 57 form the base body 10, the conductor patterns 61 to 64 and the via conductors form the coil conductor 25, and the conductor patterns 71 form the base electrode layer for the first and second external electrodes 21 and 22.

Next, the first and second external electrodes 21 and 22 are formed by forming a plating layer on the base electrode layer. The plating layer is formed by, for example, the electrolytic or electroless plating method. The plating layer may include two or more plating layers. For example, a nickel plating layer may be formed on the base electrode layer, and a tin plating layer may be formed on the nickel plating layer.

In the above-described manner, the coil component 1 is manufactured. In the manufacturing process of the coil component 1, the chip laminate may be polished by barrel-polishing or the like. The corners and ridges of the base body 10 can be rounded by polishing.

### (4) Notes

The dimensions, materials, and arrangements of the constituent elements described for the above various embodiments are not limited to those explicitly described for the embodiments, and these constituent elements can be modified to have any dimensions, materials, and arrangements within the scope of the present invention.

Constituent elements not explicitly described herein can also be added to the above-described embodiments, and it is also possible to omit some of the constituent elements described for the embodiments.

The words “first,” “second,” “third” and so on used herein are added to distinguish constituent elements but do not necessarily limit the numbers, orders, or contents of the constituent elements. The numbers added to distinguish the constituent elements should be construed in each context. The same numbers do not necessarily denote the same constituent elements among the contexts. The use of numbers to identify constituent elements does not prevent the constituent elements from performing the functions of the constituent elements identified by other numbers.

The expression of “including” a constituent element used herein does not exclude other constituent elements but rather means that other constituent elements can be further included, as long as they are consistent with the invention.

### (5) Additional Embodiments

Embodiments disclosed herein also include the following.

### [Additional Embodiment 1]

A coil component comprising:
a base body (10) having a first surface (10a), a second surface (10c) connected to the first surface, a third surface (10d) opposed to the second surface in a first direction (L) and connected to the first surface, a fourth surface (10e) connected to the first surface, and a fifth surface (10f) opposed to the fourth surface in a second direction (W) orthogonal to the first direction and connected to the first surface;
a coil conductor (25) provided in the base body;
a first external electrode (21) provided on the first surface of the base body, the first external electrode being connected to one end of the coil conductor; and
a second external electrode (22) provided on the first surface of the base body so as to be spaced apart from the first external electrode in the first direction, the second external electrode being connected to another end of the coil conductor,
wherein when viewed from a normal direction to the first surface, the first external electrode is spaced apart from the second surface of the base body at a first corner region (A1) and a second corner region (A2) and is in contact with the second surface at a region other than the first corner region and the second corner region, the first corner region including a first corner (C1) where the second surface and the fourth surface intersect, the second corner region including a second corner (C2) where the second surface and the fifth surface intersect, and
wherein when viewed from the normal direction to the first surface, the second external electrode is spaced apart from the third surface of the base body at a third corner region (A3) and a fourth corner region (A4) and is in contact with the third surface at a region other than the third corner region and the fourth corner region, the third corner region including a third corner (C3) where the third surface and the fourth surface intersect, the fourth corner region including a fourth corner (C4) where the third surface and the fifth surface intersect.

### [Additional Embodiment 2]

The coil component of Additional Embodiment 1, wherein when viewed from the normal direction to the first surface, the first external electrode is spaced apart from the fourth surface at the first corner region and is in contact with the fourth surface at a region other than the first corner region.

### [Additional Embodiment 3]

The coil component of Additional Embodiment 1 or 2, wherein when viewed from the normal direction to the first surface, the first external electrode is spaced apart from the fifth surface at a second corner region and is in contact with the fifth surface at a region other than the second corner region.

### [Additional Embodiment 4]

The coil component of any one of Additional Embodiments 1 to 3, wherein the first corner region includes a first flat portion constituting a part of the first surface and interposed between the first external electrode and the second surface and between the first external electrode and the fourth surface.

### [Additional Embodiment 5]

The coil component of any one of Additional Embodiments 1 to 4, wherein when viewed from the normal direction to the first surface, the first external electrode includes a curved portion (21a) curved convexly toward the first corner region.

### [Additional Embodiment 6]

The coil component of any one of Additional Embodiments 1 to 5, further comprising an insulating film provided on the first surface of the base body.

### [Additional Embodiment 7]

The coil component of any one of Additional Embodiments 1 to 6, wherein the base body contains a plurality of metal magnetic particles.

### [Additional Embodiment 8]

A coil component comprising:
a base body (10) having a first surface (10a), a second surface (10c) connected to the first surface, a third surface (10d) opposed to the second surface in a first direction (L) and connected to the first surface, a fourth surface (10e) connected to the first surface, and a fifth surface (10f) opposed to the fourth surface in a second direction (W) orthogonal to the first direction and connected to the first surface;
a first coil conductor provided in the base body;
a second coil conductor provided in the base body;
a first external electrode (121) provided on the first surface of the base body, the first external electrode being connected to one end of the first coil conductor;
a second external electrode (122) provided on the first surface of the base body so as to be spaced apart from the first external electrode in the first direction, the second external electrode being connected to another end of the first coil conductor;
a third external electrode (123) provided on the first surface of the base body so as to be spaced apart from the first external electrode (121) in the second direction, the third external electrode being connected to one end of the second coil conductor; and
a fourth external electrode (124) provided on the first surface of the base body so as to be spaced apart from the third external electrode in the first direction, the fourth external electrode being connected to another end of the second coil conductor,
wherein when viewed from a normal direction to the first surface, the first external electrode is spaced apart from the second surface of the base body at a first corner region and is in contact with the second surface at a region other than the first corner region, the first corner region including a first corner (C1) where the second surface and the fourth surface intersect,
wherein when viewed from the normal direction to the first surface, the second external electrode is spaced apart from the third surface of the base body at a second corner region and is in contact with the third surface at a region other than the second corner region, the second corner region including a third corner (C3) where the third surface and the fourth surface intersect,
wherein when viewed from the normal direction to the first surface, the third external electrode is spaced apart from the second surface of the base body at a third corner region and is in contact with the second surface at a region other than the third corner region, the third corner region including a second corner (C2) where the second surface and the fifth surface intersect, and
wherein when viewed from the normal direction to the first surface, the fourth external electrode is spaced apart from the third surface of the base body at a fourth corner region and is in contact with the third surface at a region other than the fourth corner region, the fourth corner region including a fourth corner (C4) where the third surface and the fifth surface intersect.

What is claimed is:

1. A coil component comprising:
a base body having a first surface, a second surface connected to the first surface, a third surface opposed to the second surface in a first direction and connected to the first surface, a fourth surface connected to the first surface, and a fifth surface opposed to the fourth surface in a second direction orthogonal to the first direction and connected to the first surface;
a coil conductor provided in the base body;
a first external electrode provided on the first surface of the base body, the first external electrode being connected to one end of the coil conductor; and
a second external electrode provided on the first surface of the base body so as to be spaced apart from the first external electrode in the first direction, the second external electrode being connected to another end of the coil conductor;
wherein when viewed from a normal direction to the first surface, the first external electrode is spaced apart from the second surface of the base body at a first corner region and a second corner region and is in contact with the second surface at a region other than the first corner region and the second corner region, the first corner region including a first corner where the second surface and the fourth surface intersect, the second corner region including a second corner where the second surface and the fifth surface intersect, and
wherein when viewed from the normal direction to the first surface, the second external electrode is spaced apart from the third surface of the base body at a third corner region and a fourth corner region and is in contact with the third surface at a region other than the third corner region and the fourth corner region, the third corner region including a third corner where the third surface and the fourth surface intersect, the fourth corner region including a fourth corner where the third surface and the fifth surface intersect.

2. The coil component of claim 1, wherein when viewed from the normal direction to the first surface, the first external electrode is spaced apart from the fourth surface at the first corner region and is in contact with the fourth surface at a region other than the first corner region.

3. The coil component of claim 1, wherein when viewed from the normal direction to the first surface, the first external electrode is spaced apart from the fifth surface at a second corner region and is in contact with the fifth surface at a region other than the second corner region.

4. The coil component of claim 1, wherein the first corner region includes a first flat portion constituting a part of the first surface and interposed between the first external electrode and the second surface and between the first external electrode and the fourth surface.

5. The coil component of claim 1, wherein when viewed from the normal direction to the first surface, the first external electrode includes a curved portion curved convexly toward the first corner region.

6. The coil component of claim 1, further comprising an insulating film provided on the first surface of the base body.

7. The coil component of claim 1, wherein the base body contains a plurality of metal magnetic particles.

8. A coil component comprising:
a base body having a first surface, a second surface connected to the first surface, a third surface opposed to the second surface in a first direction and connected to the first surface, a fourth surface connected to the first surface, and a fifth surface opposed to the fourth surface in a second direction orthogonal to the first direction and connected to the first surface;
a first coil conductor provided in the base body;
a second coil conductor provided in the base body;
a first external electrode provided on the first surface of the base body, the first external electrode being connected to one end of the first coil conductor;
a second external electrode provided on the first surface of the base body so as to be spaced apart from the first external electrode in the first direction, the second external electrode being connected to another end of the first coil conductor;
a third external electrode provided on the first surface of the base body so as to be spaced apart from the first external electrode in the second direction, the third external electrode being connected to one end of the second coil conductor; and
a fourth external electrode provided on the first surface of the base body so as to be spaced apart from the third external electrode in the first direction, the fourth external electrode being connected to another end of the second coil conductor,
wherein when viewed from a normal direction to the first surface, the first external electrode is spaced apart from the second surface of the base body at a first corner region and is in contact with the second surface at a region other than the first corner region, the first corner region including a first corner where the second surface and the fourth surface intersect,
wherein when viewed from the normal direction to the first surface, the second external electrode is spaced apart from the third surface of the base body at a second corner region and is in contact with the third surface at a region other than the second corner region, the second corner region including a third corner where the third surface and the fourth surface intersect,
wherein when viewed from the normal direction to the first surface, the third external electrode is spaced apart from the second surface of the base body at a third corner region and is in contact with the second surface at a region other than the third corner region, the third corner region including a second corner where the second surface and the fifth surface intersect, and
wherein when viewed from the normal direction to the first surface, the fourth external electrode is spaced apart from the third surface of the base body at a fourth corner region and is in contact with the third surface at a region other than the fourth corner region, the fourth corner region including a fourth corner where the third surface and the fifth surface intersect.
